(19) United States
(12) Patent Application Publication
(10) Pub. No.: US 2022/0278993 A1
(43) Pub. Date: Sep. 1, 2022

(54) AN ORGANIZATIONAL CYBER SECURITY SYSTEM AND METHOD

(71) Applicant: CyTwist LTD., Ramat Gan (IL)

(72) Inventors: Yosef KORAKIN, Ramat Gan (IL); Yehonadav HERTZ, Ramat Gan (IL); Ben EISENTHAL, Ramat Gan (IL)

(21) Appl. No.: 17/634,254

(22) PCT Filed: Aug. 30, 2020
(86) PCT No.: PCT/IL2020/050942

§ 371 Date: Feb. 10, 2022

Related U.S. Application Data
(60) Provisional application No. 62/895,998, filed on Sep. 5, 2019.

(51) Int. Cl. H04L 9/40

(52) U.S. Cl. CPC H04L 63/145; H04L 63/1416; H04L 63/1425; H04L 63/20

(57) ABSTRACT

An organizational cyber security system, the organizational cyber security system comprising a processing resource configured to: obtain: (a) organization characterization information characterizing an organization and (b) known threats information of known cyber security threats; identify one or more potential threats of the known cyber security threats that pose the respective threats to the organization, being the known cyber security threats that are executable on the organizational assets according to the organization characterization information; and generate one or more attack scenarios simulating execution of one or more of the potential threats on one or more of the organizational assets, being target organizational assets.

### TECHNICAL FIELD

The invention relates to an organizational cyber security system and method.

### BACKGROUND

Organizational cyber security systems are in use for years. Typically, such systems are based on dedicated defensive cyber protection layers. However, such systems fail to detect various types of cyber-attacks, which exploit cyber vulnerabilities that are unknown to such systems. In addition, such cyber security systems usually do not consider logical business assets of the organization they protect whatsoever, and certainly the importance of such logical business assets to the organization. Still further, Current cyber security systems do not provide the executives of organizations with tools for understanding the resilience of their organization to cyber threats posed on organization and more specifically on the logical business assets thereof. There is thus a need in the art for a new organizational cyber security system and method.

### GENERAL DESCRIPTION

In accordance with a first aspect of the presently disclosed subject matter, there is provided an organizational cyber security system, the organizational cyber security system comprising processing circuitry configured, as part of performing a process, to: obtain: (a) organization characterization information characterizing an organization, the organization characterization information including at least one of: (i) organizational assets information of organizational assets of the organization, (ii) configurations information of configurations of the organizational assets, and (iii) relationships information of relationships between the organizational assets; and (b) known threats information of known cyber security threats, wherein each of the cyber security threats poses a threat on respective target organizations associated with target characterization information including at least one of: (i) target organizational assets information of target organizational assets of the respective target organization, (ii) target configurations information of target configurations of the target organizational assets, and (iii) target relationships information of target relationships between the target organizational assets; identify one or more potential threats of the known cyber security threats that pose the respective threats to the organization, being the known cyber security threats that are executable on the organizational assets according to the organization characterization information; and generate one or more attack scenarios simulating execution of one or more of the potential threats on one or more of the organizational assets, being target organizational assets.

In some cases, the processing circuitry is further configured, as part of performing the process, to repeatedly: receive signals collected from at least one of the organizational assets, each of the signals being indicative of a respective activity performed on one or more of the organizational assets at a respective time; and determine, for each of the attack scenarios, a risk score indicative of a likelihood of the respective attack scenario taking place on the organization by analyzing the signals.

In some cases, at least some of the signals are collected by agents executing on the organizational assets.

In some cases, at least some of the signals are obtained from organizational alert systems.

In some cases, the processing circuitry is further configured, as part of performing the process, to provide a visualization of the risk scores.

In some cases, the processing circuitry is further configured, as part of performing the process, to perform one or more manipulation actions manipulating the configurations of the organizational assets, or manipulating the relationships between the organizational assets, giving rise to updated organization characterization information.

In some cases, the organization characterization information further includes, for each of the organizational assets, a respective business value grade, and wherein the manipulation actions are deteimined also based on the business value grade associated with affected organizational assets, being the organizational assets that are affected by the manipulation actions.

In some cases, the manipulation actions manipulate at least one of: (a) the configuration of at least one of the target organizational assets, or (b) the relationships between at least one of the target organizational assets and another organizational asset of the organizational assets.

In some cases, the manipulation action is based on identification of the attack scenarios associated with respective risk scores that exceed a threshold.

In some cases, the processing circuitry is further configured to reperform the process using the updated organization characterization information instead of the organization characterization information.

In some cases, the processing circuitry is further configured, as part of performing the process, to perform one or more manipulation actions manipulating at least some of the agents, being manipulated agents.

In some cases, at least one given manipulated agent of the manipulated agents is executing on a respective target organizational asset of the target organizational assets.

In some cases, the manipulation is based on identification of the attack scenarios associated with respective risk scores that exceed a threshold.

In some cases, the manipulation causes the respective agents to collect additional signals in addition to the signals.

In some cases, the additional signals are determined based on characteristics of at least one given potential threat of the potential threats.

In some cases, the given potential threat is associated with at least one given attack scenario of the attack scenarios that is associated with a risk score below a threshold.

In some cases, the risk score is also based on business values of at least one of the organizational assets on which the given potential threat is posed.

In some cases, the manipulation causes the respective agents to collect at least some the signals at a different frequency, different than a current frequency of collecting the respective signals.

In some cases, the manipulation causes the respective agents to cause at least one application executing on the respective organizational asset in a debug mode.

In some cases, the processing circuitry is further configured, as part of performing the process, to perform one or more manipulation actions manipulating at least some of the organizational alert systems, wherein the manipulation actions are determined based on characteristics of at least one given potential threat of the potential threats.

In some cases, the given potential threat is associated with at least one given attack scenario of the attack scenarios that is associated with a risk score that exceeds a threshold.

In some cases, the manipulation includes changing alert generation rules of the respective organizational alert systems.

In some cases, the manipulation includes defining a filter on the alerts generated by the organizational alert systems.

In some cases, the filter is based on a severity level of the alerts.

In some cases, the processing circuitry is further configured, as part of performing the process, to perform one or more disruption actions for disrupting at least one given potential threat of the potential threats that is associated with at least one given attack scenario of the attack scenarios that is associated with a respective risk score that exceeds a threshold.

In some cases, the disruption action includes deploying at least one honeypot on at least one of the organizational assets.

In some cases, the processing circuitry is further configured, as part of the process, to provide a visualization of the potential threats.

In accordance with a second aspect of the presently disclosed subject matter, there is provided an organizational cyber security method, comprising, as part of performing a process: obtaining, by a processing circuitry: (a) organization characterization information characterizing an organization, the organization characterization information including at least one of: (i) organizational assets information of organizational assets of the organization, (ii) configurations information of configurations of the organizational assets, and (iii) relationships information of relationships between the organizational assets; and (b) known threats information of known cyber security threats, wherein each of the cyber security threats poses a threat on respective target organizations associated with target characterization information including at least one of: (i) target organizational assets information of target organizational assets of the respective target organization, (ii) target configurations information of target configurations of the target organizational assets, and (iii) target relationships information of target relationships between the target organizational assets; identifying, by the processing circuitry, one or more potential threats of the known cyber security threats that pose the respective threats to the organization, being the known cyber security threats that are executable on the organizational assets according to the organization characterization information; and generating, by the processing circuitry, one or more attack scenarios simulating execution of one or more of the potential threats on one or more of the organizational assets, being target organizational assets.

In some cases, the method further comprises, as part of performing the process, repeatedly: receiving, by the processing circuitry, signals collected from at least one of the organizational assets, each of the signals being indicative of a respective activity performed on one or more of the organizational assets at a respective time; and determining, by the processing circuitry, for each of the attack scenarios, a risk score indicative of a likelihood of the respective attack scenario taking place on the organization by analyzing the signals.

In some cases, at least some of the signals are collected by agents executing on the organizational assets.

In some cases, at least some of the signals are obtained from organizational alert systems.

In some cases, the method further comprises, as part of performing the process, providing, by the processing circuitry, a visualization of the risk scores.

In some cases, the method further comprises, as part of performing the process, performing, by the processing circuitry, one or more manipulation actions manipulating the configurations of the organizational assets, or manipulating the relationships between the organizational assets, giving rise to updated organization characterization information.

In some cases, the organization characterization information further includes, for each of the organizational assets, a respective business value grade, and the manipulation actions are determined also based on the business value grade associated with affected organizational assets, being the organizational assets that are affected by the manipulation actions.

In some cases, the manipulation actions manipulate at least one of: (a) the configuration of at least one of the target organizational assets, or (b) the relationships between at least one of the target organizational assets and another organizational asset of the organizational assets.

In some cases, the manipulation action is based on identification of the attack scenarios associated with respective risk scores that exceed a threshold.

In some cases, the method further comprises reperforming the process using the updated organization characterization information instead of the organization characterization information.

In some cases, the method further comprises, as part of performing the process, performing, by the processing circuitry, one or more manipulation actions manipulating at least some of the agents, being manipulated agents.

In some cases, at least one given manipulated agent of the manipulated agents is executing on a respective target organizational asset of the target organizational assets.

In some cases, the manipulation is based on identification of the attack scenarios associated with respective risk scores that exceed a threshold.

In some cases, the manipulation causes the respective agents to collect additional signals in addition to the signals.

In some cases, the additional signals are determined based on characteristics of at least one given potential threat of the potential threats.

In some cases, the given potential threat is associated with at least one given attack scenario of the attack scenarios that is associated with a risk score below a threshold.

In some cases, the risk score is also based on business values of at least one of the organizational assets on which the given potential threat is posed.

In some cases, the manipulation causes the respective agents to collect at least some the signals at a different frequency, different than a current frequency of collecting the respective signals.

In some cases, the manipulation causes the respective agents to cause at least one application executing on the respective organizational asset in a debug mode.

In some cases, the method further comprises, as part of performing the process, performing, by the processing circuitry, one or more manipulation actions manipulating at least some of the organizational alert systems, wherein the manipulation actions are determined based on characteristics of at least one given potential threat of the potential threats.

In some cases, the given potential threat is associated with at least one given attack scenario of the attack scenarios that is associated with a risk score that exceeds a threshold.

In some cases, the manipulation includes changing alert generation rules of the respective organizational alert systems.

In some cases, the manipulation includes defining a filter on the alerts generated by the organizational alert systems.

In some cases, the filter is based on a severity level of the alerts.

In some cases, the method further comprises, as part of performing the process, performing, by the processing circuitry, one or more disruption actions for disrupting at least one given potential threat of the potential threats that is associated with at least one given attack scenario of the attack scenarios that is associated with a respective risk score that exceeds a threshold.

In some cases, the disruption action includes deploying at least one honeypot on at least one of the organizational assets.

In some cases, the method further comprises, as part of the process, providing, by the processing circuitry, a visualization of the potential threats.

In accordance with a third aspect of the presently disclosed subject matter, there is provided a non-transitory computer readable storage medium having computer readable program code embodied therewith, the computer readable program code, executable by at least one processor of a computer to perform a method comprising, as part of performing a process: obtaining, by a processing circuitry: (a) organization characterization information characterizing an organization, the organization characterization information including at least one of: (i) organizational assets information of organizational assets of the organization, (ii) configurations information of configurations of the organizational assets, and (iii) relationships information of relationships between the organizational assets; and (b) known threats information of known cyber security threats, wherein each of the cyber security threats poses a threat on respective target organizations associated with target characterization information including at least one of: (i) target organizational assets information of target organizational assets of the respective target organization, (ii) target configurations information of target configurations of the target organizational assets, and (iii) target relationships information of target relationships between the target organizational assets; identifying, by the processing circuitry, one or more potential threats of the known cyber security threats that pose the respective threats to the organization, being the known cyber security threats that are executable on the organizational assets according to the organization characterization information; and generating, by the processing circuitry, one or more attack scenarios simulating execution of one or more of the potential threats on one or more of the organizational assets, being target organizational assets.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an organizational network, in accordance with the presently disclosed subject matter;

FIG. 2 is a block diagram schematically illustrating one example of an organizational cyber security system, in accordance with the presently disclosed subject matter;

FIG. 3 is a flowchart illustrating one example of a sequence of operations carried out for generating attach scenarios, in accordance with the presently disclosed subject matter;

FIG. 4 is a flowchart illustrating one example of a sequence of operations carried out for analyzing signals collected from organizational assets, in accordance with the presently disclosed subject matter; and

FIG. 5 is a flowchart illustrating one example of a sequence of operations carried out for discovering and ranking organizational assets, in accordance with the presently disclosed subject matter.

### DETAILED DESCRIPTION

In the following detailed description, numerous specific details are set forth in order to provide a thorough understanding of the presently disclosed subject matter.

However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “performing”, “obtaining”, “identifying”, “generating”, “receiving”, “determining”, “reperforming”, “providing”, “analyzing” or the like, include action and/or processes of a computer that manipulate and/or transform data into other data, said data represented as physical quantities, e.g. such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

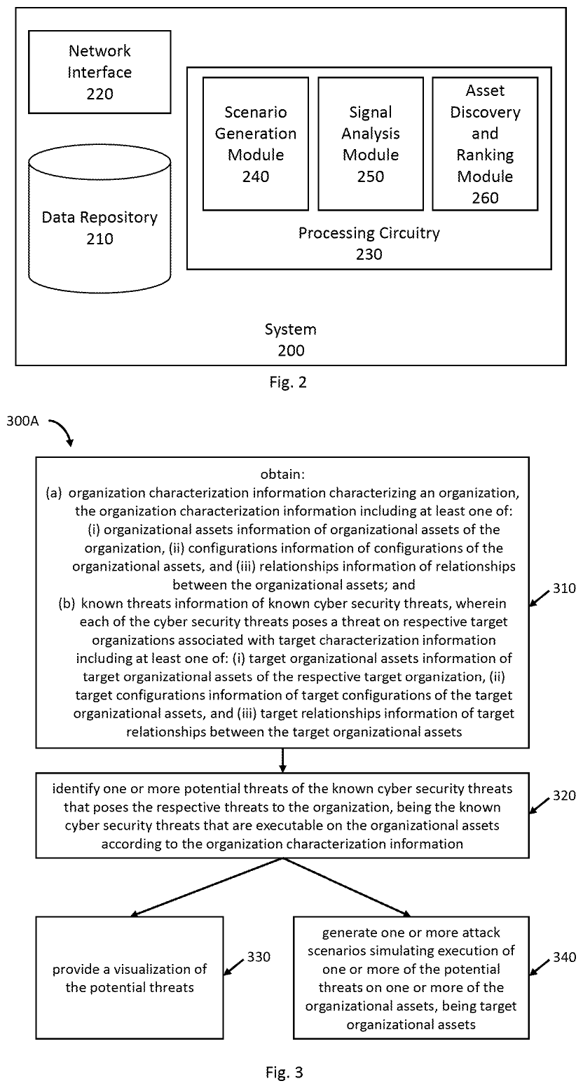

In embodiments of the presently disclosed subject matter, fewer, more and/or different stages than those shown in FIGS. 3-5 may be executed. In embodiments of the presently disclosed subject matter one or more stages illustrated in FIGS. 3-5 may be executed in a different order and/or one or more groups of stages may be executed simultaneously. FIG. 2 illustrates a general schematic of the system architecture in accordance with an embodiment of the presently disclosed subject matter. Each module in FIG. 2 can be made up of any combination of software, hardware and/or firmware that performs the functions as defined and explained herein. The modules in FIG. 2 may be centralized in one location or dispersed over more than one location. In other embodiments of the presently disclosed subject matter, the system may comprise fewer, more, and/or different modules than those shown in FIG. 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

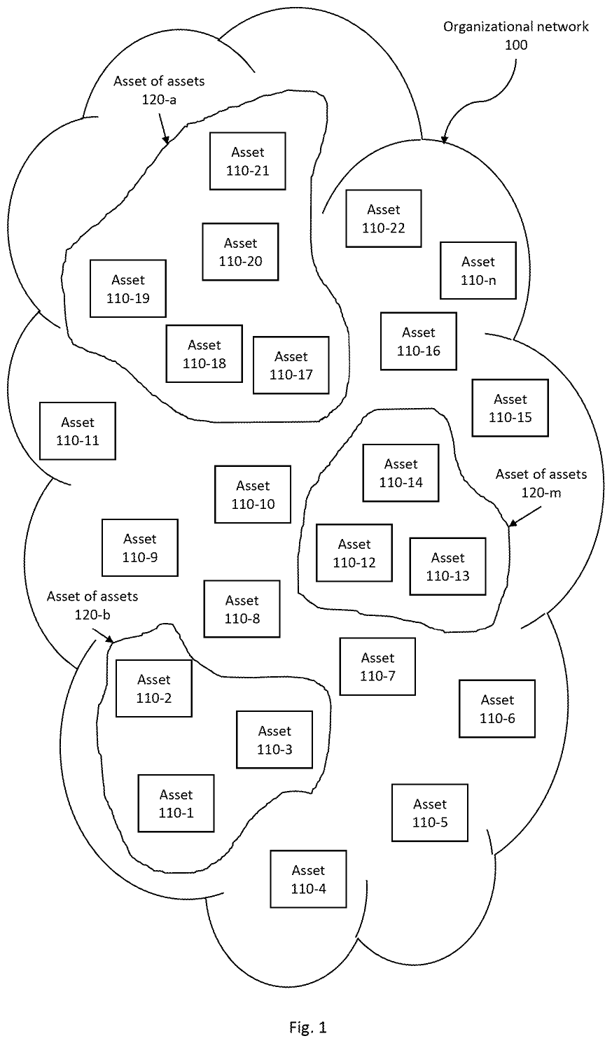

Bearing this in mind, attention is drawn to FIG. 1, a schematic illustration of an organizational network, in accordance with the presently disclosed subject matter.

An organizational network 100 of an organization (e.g. a company, a non-profit organization, a governmental organization, or any other type of organization) comprises a plurality of organizational assets (asset 110-1, asset 110-2, ..., asset 110-n), that can connect to the organizational network 100, or to parts thereof, via a wired and/or a wireless connection. The organizational assets can be, for example, personal computers, laptop computers, servers, modems, gateways, routers, printers, switches, controllers, Internet of Things (IoT) devices, Internet Protocol (IP) phones, smartphones, smart televisions, or any other device that forms part of an organizational network 100, or that can connect to the organizational network 100 or that is accessible via the organizational network 100. As one can appreciate, the organizational assets can include Operational Technology (OT) devices and/or Information Technology (IT) devices. It is to be noted that the organizational network 100 can be comprised of a plurality of sub-networks that can optionally be interconnected (whether unidirectionally or bidirectionally). It is to be noted that the term “asset” and the term “organizational asset” are used interchangeably throughout the detailed description.

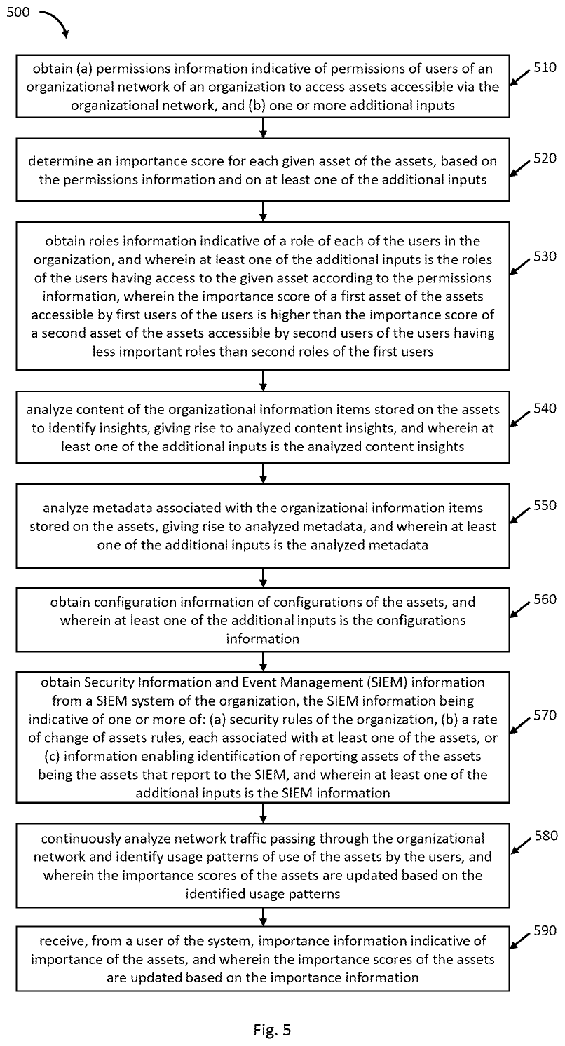

In some cases, access to the organizational assets, or at least to some of the organizational assets, can be restricted so that only entities (whether a human entity or a computerized entity such as a software application) that have permissions can access the respective organizational assets (or certain sections thereon, such as certain folders within an organizational asset that is a computer that has a file system with a plurality of folders, etc.). Having information on the permissions to access the organizational assets, along with one or more additional inputs (as further detailed herein, inter alia with reference to FIG. 5) can enable ranking a business importance of the respective organizational assets. For example, a certain organizational asset that is accessible only by the organization's Chief Executive Officer (CEO) and by the organization's Chief Financial Officer (CFO) has higher business value than another organizational asset that is accessible only by the organization's Human Resource (HR) manager's secretary. A further explanation about the organizational asset's business value determination/ranking is provided herein, inter alia with reference to FIG. 5.

It is to be noted that information about permissions can be obtained from an Active Directory (AD) and/or from an Identity Management system (IdM) and/or from a Cloud Access Security Broker (CASB) of the organization, or from any other system that enables control of access to the organizational assets connected to, or accessible via, the organizational network 100.

In some cases, sub-groups of the organizational assets serve a certain business need of the organization, or different part/s of the organization. In such cases, those organizational assets that serve the business need of the organization (or different part/s thereof) can be referred to as an asset of assets (asset of assets 110-a, asset of assets 110-b, ..., asset of assets 110-m). For example, a group of organizational assets that are required in order to enable email communication within, and from, the organization, can be referred to as an asset of assets. Having the ability to communicate within the organization, and with external entities, external to the organization, is in most cases extremely important to the organization, and even more so for sales personal within the organization. As another example, a group of organizational assets that are required in order to enable printing documents from computers of the housekeeping team can be referred to as an asset of assets. In most organizations maintaining the ability of the housekeeping team to print documents is not important, or at least less important than the asset of assets that are required in order to enable sales personal to communicate with entities within the organization or external to the organization. Assets that are related to billing systems of the organization are also usually considered extremely important to the organization, more than assets that relate to housekeeping. As yet another example, an asset of assets that are required for enabling a Research and Development (R&D) division of a company that develops computerized products are crucial for its ability to operate, and such asset of assets is more important than assets that are only used by a secretary working for such company.

Each asset of assets has a different business value, and such business value can be considered when planning/designing a cyber-protection strategy for the organization, as further detailed herein.

At least some of the organizational assets connected to, or accessible via, the organizational network 100 are configurable, and their configuration affects the organization's sensitivity to cyber-attacks. For example, permissions can be set to some of the organizational assets in a manner that allows such organizational assets to access other organizational assets, or assets of assets, that comprise sensitive information, without an actual need. This results in a security hole that may be exploited by cyber attackers to infiltrate portions of the organizational network 100 that comprise sensitive information. Such security hole can be exploited by an attacker that can laterally infiltrate organizational assets and access the sensitive information.

Some of the organizational assets may have relationships with other organizational assets. For example, a given organizational asset such as a desktop computer of a sales representative of the organization, can be connected to a Customer Relationship Management (CRM) system that is installed on a dedicated server which is another organizational asset, which in turn is connected to a database server which is yet another organizational asset.

Some of the organizational assets (or assets of assets) can be various types of cyber security systems, including, for example, organizational alert systems (e.g. a Security Information and Event Management (SIEM) system as known in the art), configured to provide alerts indicative of potential cyber threats on the organizational network identified by the organizational alert systems. The alerts are provided based on analysis of data collected by organizational alert systems using configurable rules.

Having briefly described the organizational network, attention is drawn to FIG. 2, a block diagram schematically illustrating one example of an organizational cyber security system, in accordance with the presently disclosed subject matter.

According to certain examples of the presently disclosed subject matter, an organizational cyber security system 200 comprises a network interface 220 enabling connecting the organizational cyber security system 200 to the organizational network 100 and enabling it to send and receive data sent thereto through the organizational network 100, including receiving information collected by agents installed on the organizational assets (asset 110-1, asset 110-2, ..., asset 110-n), receiving information of known threats (that can be retrieved from the Internet and/or from dedicated suppliers of such information), receiving information of permissions of entities to access organizational assets (e.g. from an AD, an IdM, a CASB, or from any other source that comprises information on permissions to access organizational assets), and/or sending instructions for manipulating configurations of organizational assets and/or for manipulating agents executing on the organizational assets and/or for manipulating organizational alert systems and/or for disrupting potential threats, as detailed herein, inter alia with reference to FIGS. 3-5.

Organizational cyber security system 200 can further comprise or be otherwise associated with a data repository 210 (e.g. a database, a storage system, a memory including Read Only Memory—ROM, Random Access Memory—RAM, or any other type of memory, etc.) configured to store data, including, inter alia, information of organizational assets connected to the organizational network 100, configurations of organizational assets connected to the organizational network 100, relationships between organizational assets connected to the organizational network 100, known cyber security threats, permissions information of permissions of entities to access organizational assets, etc. In some cases, data repository 330 can be further configured to enable retrieval and/or update and/or deletion of the data stored thereon. It is to be noted that in some cases, data repository 210 can be distributed.

Organizational cyber security system 200 further comprises processing circuitry 230. Processing circuitry 230 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant organizational cyber security system 200 resources and for enabling operations related to organizational cyber security system 200 resources.

The processing circuitry 230 comprises one or more of the following modules: scenario generation module 240, signal analysis module 250, and asset discovery and ranking module 260.

Scenario generation module 240 can be configured to perform a process for generating attack scenarios simulating execution of potential threats on the organizational assets, as further detailed herein, inter alia with reference to FIG. 3.

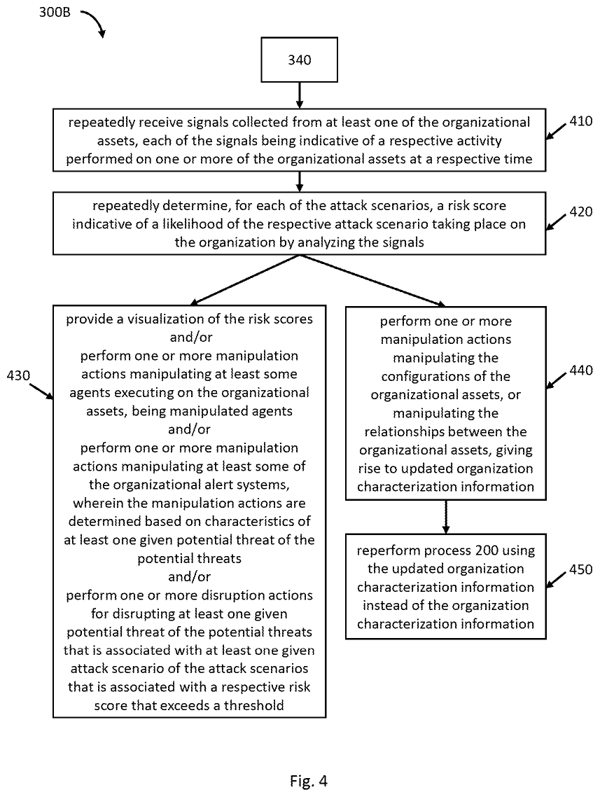

Signal analysis module 250 can be configured to perform a process for analyzing collected signals and perform one or more actions based on the results of the signal analysis, as further detailed herein, inter alia with reference to FIG. 4.

Asset discovery and ranking module 260 can be configured to perform an asset discovery and ranking process, as further detailed herein, inter alia with reference to FIG. 5.

Turning to FIG. 3, there is shown a flowchart illustrating one example of a sequence of operations carried out for generating attack scenarios, in accordance with the presently disclosed subject matter.

According to certain examples of the presently disclosed subject matter, organizational cyber security system 200 can be configured to perform an attack scenario generation process 300a, e.g. utilizing the scenario generation module 240.

For this purpose, organizational cyber security system 200 can be configured to obtain (e.g. receive as input, retrieve from data repository 210, retrieve from external resource/s): (a) organization characterization information characterizing an organization, and (b) known threats information of known cyber security threats, wherein each of the known cyber security threats poses a threat on respective target organizations associated with target characterization information (block 310).

The organization characterization information includes at least one of:
(i) organizational assets information of organizational assets of the organization (asset 110-1, asset 110-2, ..., asset 110-n, asset of assets 120-a, asset of assets 120-b, ..., asset of assets 120-m), which can include identifiers of the organizational assets, their Internet Protocol (IP) address (if they have an IP address), their network location, metadata characterizing respective organizational assets (e.g. make, model, operating system type, operating system version, installed software, location, etc.), or any other information required for identifying the organizational assets and optionally enabling communicating therewith;
(ii) configurations information of configurations of the organizational assets, which can include information of software installed thereon (including software versions and software configuration, information of permissions of entities to access respective organizational assets), information relating to its networking capabilities (e.g. network connection settings, information of open ports, etc.), information of devices physically connected thereto (e.g. network camera, printer, etc.), etc.; or
(iii) relationships information of relationships between the organizational assets, which can include information of organizational assets that are interconnected, or designed to communicate with each other (as detailed above: a given organizational asset such as a desktop computer of a sales representative of the organization, can be connected to a Customer Relationship Management (CRM) system that is installed on a dedicated server which is another asset, which in turn is connected to a database server which is yet another organizational asset).

The known threats information includes, for each known cyber security threat, at least one of:
(i) target organizational assets information of target organizational assets of the respective target organization, defining what are the target assets of the known cyber security threat (as different threats target different targets. For example, one cyber security threat can target certain types of personal computers or servers within the organization, while another threat can target, for example, Internet of Things (IoT) devices);
(ii) target configurations information of target configurations of the target organizational assets, which define the configurations of those target organizational assets that are required in order to enable attacking them (e.g. lack of a security patch, open ports, required permissions, etc.); or
(iii) target relationships information of target relationships between the target organizational assets (e.g. if a given cyber security threat is designed to get to a certain target server through a certain computer, the computers that are relevant for the attack are those through which the attack get move to the target server).

The known threats information can be obtained, inter alia, from public sources, such as MITRE (https://attack.mitre.org).

Using the organization characterization information and the known threats information, the organizational cyber security system 200 identifies one or more potential threats of the known cyber security threats that pose a threat to the organization (block 320). The potential threats are those known cyber security threats that can be executed on the organizational assets according to the organization characterization information and the known threats information.

In some cases, the organizational cyber security system 200 can be configured to provide a visualization of the potential threats (i.e. those known cyber security threats that can be executed on the organizational assets) (block 330). The visualization can be, for example, a list displayed to a user of the organizational cyber security system 200 on a display.

Additionally, or alternatively, the organizational cyber security system 200 can be configured to generate one or more attack scenarios simulating execution of one or more of the potential threats (i.e. those known cyber security threats that can be executed on the organizational assets) on one or more of the organizational assets (asset 110-1, asset 110-2, ..., asset 110-n, asset of assets 120-a, asset of assets 120-b, ..., asset of assets 120-m), which are referred to herein as target organizational assets (block 340). Those attack scenarios can be executed on the organizational assets in order to identify vulnerabilities of the organizational assets individually, or the organizational network 100 as a whole, and perform measures that address such vulnerabilities, e.g. as further detailed herein, with reference to FIG. 4.

It is to be noted that, with reference to FIG. 3, some of the blocks can be integrated into a consolidated block or can be broken down to a few blocks and/or other blocks may be added. Furthermore, in some cases, the blocks can be performed in a different order than described herein (for example, block 340 can be performed before block 330, etc.). It is to be further noted that some of the blocks are optional. It should be also noted that whilst the flow diagram is described also with reference to the system elements that realizes them, this is by no means binding, and the blocks can be performed by elements other than those described herein.

FIG. 4 shows a flowchart illustrating one example of a sequence of operations carried out for analyzing signals collected from organizational assets, in accordance with the presently disclosed subject matter.

According to certain examples of the presently disclosed subject matter, organizational cyber security system 200 can be configured to perform a signal analysis process 300b, e.g. utilizing the signal analysis module 250.

For this purpose, organizational cyber security system 200 can be configured to repeatedly receive signals collected from at least one of the organizational assets, each of the signals being indicative of a respective activity (e.g. file open, file delete, file close, command executed, configuration changed, change permissions, registry key/value changed, or any other activity) performed on one or more of the organizational assets at a respective time (block 410). In some cases, at least some of the signals are collected by software agents executing on the organizational assets, optionally agents installed on a kernel of the operating system of the organizational assets. Additionally, or alternatively, at least some of the signals are obtained from organizational alert systems such as a Security Information and Event Management (SIEM) system that collects security alert information from various sources.

The received signals are continuously or repeatedly (e.g. every pre-determined time period) analyzed to determine, for each of the attack scenarios (generated at block 340), a risk score indicative of a likelihood of the respective attack scenario taking place and affecting the organization (block 420). It is to be noted, in this respect, that the likelihood of an attack scenario to affect an organization is dynamic by its nature, as various parameters related to the organizational assets are configurable, and each change of configuration may have an impact on such likelihood. For example, if a certain port of a certain organizational asset was closed and a command caused it to open—clearly the likelihood of an attack scenario that exploits such open port to execute substantially increases.

In some cases, the risk score can be a function of the impact the risk may have on the organization and a probability of the risk being realized. The impact can be a function of the importance of the asset (or asset of assets) on which the risk is posed (the higher the importance—the higher the impact). The probability can be determined based on one or more of: (a) proximity of the asset on which the signal was identified to a target asset of the threat (the closer it is—the higher the probability is), (b) existing vulnerabilities on assets on the path from the asset on which the signal was identified to a target asset of the threat (the more vulnerabilities—the higher the probability is), (c) progression on the attack scenario (also referred to as an attack vector) (the more progress made—the higher the probability is).

Based on the risk scores, the organizational cyber security system 200 can perform one or more actions (block 430). The actions that can be performed by the organizational cyber security system 200 can include providing a visualization of the risk scores. The visualization can be in a form of a map, a table, plain text, or any other form, and it can be displayed on a display, or provided in any other manner to a user of the organizational cyber security system 200.

Additionally, or alternatively, the actions can include performing one or more manipulation actions manipulating at least some of the software agents (the agents on which the manipulation actions are performed are referred to as “manipulated agents”). In some cases, at least one given manipulated agent of the manipulated agents is executing on a respective target organizational asset of the target organizational assets (asset 110-1, asset 110-2, ..., asset 110-n). In some cases, the manipulation of the agents is based on identification of the attack scenarios associated with respective risk scores that exceed a threshold, so that more information that may be related to the likelihood of such attack scenarios taking place is gathered. The agents can be manipulated to collect more signals, e.g. by changing the sampling frequency (so that the respective agents collect at least some the signals at a different frequency, different than a current frequency of collecting the respective signals) and/or by causing them to collect additional signals on top of the signals that were collected on block 410 and/or by causing them to collect less signals than the signals that were collected on block 410. The additional signals can be determined based on characteristics of at least one given potential threat of the potential threats (e.g. what weaknesses the given potential threat exploits, how the given potential threat operates, etc.). In some cases, the manipulation of the agents can cause at least one application executing on the respective organizational assets to execute in a debug mode (thereby enabling collecting additional signals relating to such application). It is to be noted that the debug mode is any operation mode of the application that causes it to generate more signals than those generated in a regular operation mode thereof.

In some cases, it may be desired to direct the organizational cyber security system 200 to check certain threats with more scrutiny. In such cases, the given potential threat whose characteristics are basis for the determination of the additional signals to collect, can be associated with at least one given attack scenario of the attack scenarios that is associated with a risk score below a threshold (which would not have been checked so thoroughly unless directed by the cyber security system 200). It is to be noted that the risk score can be also based on business values (represented by importance scores, as further detailed herein, inter alia with reference to FIG. 5) of at least one of the organizational assets on which the given potential threat is posed, and such business value may be higher than business values of other organizational assets which do not require protection at a scrutiny level as high as the organizational assets on which the given potential threat is posed.

Additionally, or alternatively, the actions that can be performed at block 430 can include performing one or more manipulation actions manipulating at least some of the organizational alert systems (e.g. SIEM/s), while the manipulation actions can be determined based on characteristics of at least one of the potential threats. In some cases, the given potential threat is associated with at least one given attack scenario of the attack scenarios that is associated with a risk score (determined at block 420) that exceeds a threshold.

In some cases, the manipulation includes changing alert generation rules of the respective organizational alert systems, so that alerts will be generated based on the changed alert generation rules. In some cases, the manipulation includes defining a filter on the alerts generated by the organizational alert systems, so that some alerts will be filtered out. In some cases, the filter can be based on a severity level of the alerts, so that only alerts that exceed a certain severity level are generated, whereas alerts below such severity level are filtered out.

Additionally, or alternatively, the actions that can be performed at block 430 can include performing one or more disruption actions for disrupting at least one given potential threat of the potential threats that is associated with at least one given attack scenario of the attack scenarios that is associated with a respective risk score that exceeds a threshold. In some cases, the disruption action can include deploying at least one honeypot on at least one of the organizational assets, to disrupt activity of the attack according to the given attack scenario.

Additionally, or alternatively, to the actions performed at block 430, the organizational cyber security system 200 can be configured to perform one or more manipulation actions manipulating the configurations of the organizational assets, or manipulating the relationships between the organizational assets, giving rise to updated organization characterization information (block 440). The manipulation action can be designed to reduce the likelihood of the respective attack scenario taking place and affecting the organizational network 100. Some exemplary manipulation actions can include installing security patches, closing ports, installing/uninstalling software (e.g. antivirus/firewall/other), changing internal permissions (internal to the organizational asset), changing external permissions (e.g. permissions to access organizational assets other than the organizational asset that is manipulated), closing connections to external organizational assets (external to the organizational asset that is manipulated), etc. In some cases, the manipulation action is based on identification of those attack scenarios that are associated with risk scores (determined on block 420) that exceed a threshold.

In some cases, the organization characterization information further includes, for at least part, or optionally for each of the organizational assets, a respective business value grade (also referred to herein, inter alia with reference to FIG. 5, as an “importance score”, indicative of the importance of such organizational assets/assets of assets to the business), and the manipulation actions are determined also based on the business value grade associated with affected organizational assets (being the organizational assets that are affected by the manipulation actions). For example, in case the business value grade of a certain organizational asset is higher, it can be manipulated in a manner that may have a negative effect on its performance, but will improve its sustainability to the given attack scenario, whereas in case the business value grade of a certain organizational asset is lower, it can be manipulated in a manner that does not have any negative effect on its performance, but will result in a lesser sustainability to the given attack scenario.

In some cases, the manipulation actions manipulate at least one of: (a) the configuration of at least one of the target organizational assets identified as targets by the given attack scenario, or (b) the relationships between at least one of the target organizational assets identified as targets by the given attack scenario and another organizational asset of the organizational assets not identified as targets by the given attack scenario.

Upon manipulating the configuration of any of the organizational assets and/or the relationships between any of the organizational assets, the organizational cyber security system 200 reperforms the processes 300a and 300b using the updated organization characterization information instead of the organization characterization information (block 450). Clearly, such manipulations affect the likelihood of the potential threats impacting the organizational network 100, but on the other hand, such manipulations can increase the likelihood of other known cyber security threats impacting the organizational network 100. Therefore, and also in light of the fact that new cyber security threats emerge every day, the processes 300a and 300b should be repeated, optionally continuously, in order to enable dynamic cyber protection, which maintains relevance also in view of the changes of the organizational network 100, and in the face of new cyber security threats that become known.

It can be appreciated that when repeating the process 300a, in light of the manipulations made at block 340 and/or in light of emergence of new known cyber security threats, new potential threats on the organizational network 100 can be identified, and some of the threats that were identified as potential threats on the organizational network 100 may cease to be threats on the organizational network 100. Upon any change in the potential threats, clearly process 300b should, and is, also repeated in light of the newly list of identified potential threats.

It is to be noted that, with reference to FIG. 4, some of the blocks can be integrated into a consolidated block or can be broken down to a few blocks and/or other blocks may be added. Furthermore, in some cases, the blocks can be performed in a different order than described herein (for example, block 440 can be performed before block 430, etc.). It is to be further noted that some of the blocks are optional. It should be also noted that whilst the flow diagram is described also with reference to the system elements that realizes them, this is by no means binding, and the blocks can be performed by elements other than those described herein.

Attention is drawn to FIG. 5, showing a flowchart illustrating one example of a sequence of operations carried out for discovering and ranking organizational assets, in accordance with the presently disclosed subject matter.

According to certain examples of the presently disclosed subject matter, organizational cyber security system 200 can be configured to perform an asset discovery and ranking process 500, e.g. utilizing the asset discovery and ranking module 260.

For this purpose, organizational cyber security system 200 can be configured to obtain (a) permissions information indicative of permissions of users (whether human users or computerized users such as software applications) of an organizational network 100 of an organization to access assets accessible via the organizational network 100, and (b) one or more additional inputs (block 510). As indicated herein, the permission information can be obtained from one or more of: (a) an Active Directory (AD) of the organization, (b) an Identity Management system (IdM) of the organization, or (c) a Cloud Access Security Broker (CASB) of the organization, or from any other system that enables control/restriction of access to the organizational assets connected to, or accessible via, the organizational network 100. It is to be noted that in some cases the organizational assets include at least one Operational Technology (OT) asset and at least one Informational Technology (IT) asset, noting that an Operational Technology (OT) asset includes hardware and software dedicated to detecting or causing changes in physical processes through direct monitoring and/or control of physical devices such as valves, pumps, sensors, etc., and an Information Technology (IT) asset is a data-centric system for the collection, organization, storage and communication of information.

Based on the permissions information and on at least one of the additional inputs, organizational cyber security system 200 can be configured to determine an importance score for each given asset of the organizational assets (block 520). The importance score is indicative of a business importance of the respective asset to the organization (e.g. so that higher scores represent higher importance).

In some cases, the organizational cyber security system 200 is configured to obtain roles information indicative of roles of each (or at least of some) user in the organization as one of the additional inputs (block 530). The roles information can be provided to the organizational cyber security system 200 as input from a user thereof In some cases, the roles information can be derived from hierarchy information indicative of hierarchical positions of each (or at least of some) user in the organization, noting that in some organizations each entity, except the CEO, is subordinate to a single other entity.

In such cases, the importance scores of each given asset of the assets can be determined based on the permissions information (and more specifically based on information of which users have which permissions on the given asset) in combination with the roles of the users (being one of the additional inputs obtained at block 510) having access to the given asset according to the permissions information, wherein the importance score of a first asset of the assets accessible by first users of the users is higher than the importance score of a second asset of the assets accessible by second users of the users having less important roles than second roles of the first users.

In some cases, the roles information is derived from hierarchy information indicative of hierarchical positions of each of the users in the organization. In such cases, an importance of the roles is determined based on the hierarchical positions of the users in the organization, wherein the importance score of the first asset of the assets accessible by first users of the users is higher than the importance score of the second asset of the assets accessible by the second users of the users having first hierarchical positions lower than second hierarchical positions of the first users. For example, an asset that is only accessible by the CEO will have an importance score higher than an importance score of another asset that is only accessible by subordinates (whether direct subordinates or indirect subordinates) of the CEO.

In some cases, the organizational cyber security system 200 is configured to analyze content of the organizational information items stored on the assets to identify insights, giving rise to analyzed content insights (block 540). In such cases, the importance scores of the assets can be determined based on the analyzed content (and optionally also based on the permissions information of block 520 and/or also based on the hierarchy information of block 530). When the analyzed content is utilized along with the permissions information of block 520 to determine the importance score, it is to be regarded as one of the additional inputs obtained at block 510.

In some cases, the content can include legal agreements and the analyzed content insights includes legal obligations of the organization identified by the analysis of the legal agreements. In other cases, the content can include financial documents and the analyzed content includes financial obligations to the organization, or of the organization, being identified by the analysis of the financial documents. It is to be noted that the content can be analyzed using any off-the-shelf or proprietary computerized Natural Language Processing (NLP) algorithms.

Looking at an example, a certain legal agreement can include an obligation of the organization to keep certain information strictly confidential. This indicates that such information has high business value, and thus the importance score of the asset/s on which such information is stored should be higher than similar assets (whose importance score would be identical if such information didn't exist) that do not store such information. As another example, a certain financial document can include information of large annual income derived from a certain project, and in such cases the importance score of the asset/s that are related to such project should be higher than similar assets (whose importance score would be identical if such information didn't exist) that are not related to such project.

In some cases, the organizational cyber security system 200 is configured to analyze metadata associated with the organizational information items (e.g. files) stored on the assets, giving rise to analyzed metadata (block 550). In such cases, the importance scores of the assets can be determined based on the analyzed metadata (and optionally also based on the permissions information of block 520 and/or also based on the hierarchy information of block 530 and/or also based on the analyzed content insights of block 540). The analyzed metadata can include information of encryption/creation dates/last update date/last access date/author identity/number of previous versions/etc. of organizational information items (e.g. files) stored on the assets. When the analyzed metadata is utilized along with the permissions information of block 520 to determine the importance score, it is to be regarded as one of the additional inputs obtained at block 510.

Looking at an example, assuming that a certain file (being one type of organizational information item) stored on a given asset is encrypted, this indicates that such file has high business value, and hence business value of the asset on which it is stored should be higher than similar assets (whose importance score would be identical if no encrypted file existed on such asset) that do not store encrypted files.

In some cases, the organizational cyber security system 200 is configured to obtain configuration information of configurations of the assets (block 560). In such cases, the importance scores of the assets can be determined based on the configurations information (and optionally also based on the permissions information of block 520 and/or also based on the hierarchy information of block 530 and/or also based on the analyzed content insights of block 540 and/or also based on the analyzed metadata of block 550). As indicated herein, the configurations information can include information of software installed on respective assets (including software versions and software configuration), information relating to the assets networking capabilities (e.g. network connection settings, information of open ports, etc.), information of devices physically connected to assets (e.g. network camera, printer, etc.), etc.

When the configuration information is utilized along with the permissions information of block 520 to determine the importance score, it is to be regarded as one of the additional inputs obtained at block 510.

Looking at an example, assuming that a certain asset (e.g. a server) has software installed thereon that requires 2-step verification when an attempt is made to login to such software, this indicates that such asset stores sensitive information, or controls sensitive processes. Accordingly, such asset's importance score should be higher than similar assets (whose importance score would be identical if software installed thereon would also require 2-step authentication) that do not have software that require 2-step authentication.

In some cases, the organizational cyber security system 200 is configured to obtain Security Information and Event Management (STEM) information from a SIEM system of the organization, the STEM information being indicative of one or more of:

(a) security rules of the organization, (b) a rate of change of assets rules, each associated with at least one of the assets, or (c) information enabling identification of reporting assets of the assets being the assets that report to the SIEM (i.e. those assets that send information to the STEM) (block 570). In such cases, the importance scores of the assets can be determined based on the STEM information (and optionally also based on the permissions information of block 520 and/or also based on the hierarchy information of block 530 and/or also based on the analyzed content insights of block 540 and/or also based on the analyzed metadata of block 550 and/or also based on the configurations information of block 560).

When the SIEM information is utilized along with the permissions information of block 520 to determine the importance score, it is to be regarded as one of the additional inputs obtained at block 510.

Looking at an example, assuming that the STEM information indicates that a certain asset is associated with a high number of security rules, higher than any other organizational asset, this indicates that such asset is guarded more than other assets and hence it is more important to the organization's business. Accordingly, such asset's importance score should be higher than similar assets (whose importance score would be identical if the STEM information indicated that the number of security rules associated therewith is identical to the number of security rules associated with such asset) that have fewer security rules associated therewith according to the SIEM information.

As another example, assuming that the SIEM information indicates that a certain asset reports to the SIEM (e.g. sends one or more logs thereof to the STEM), whereas another asset does not send any information to the SIEM. The asset that sends information to the SIEM should have a higher importance score than the other asset that does not report to the SIEM (assuming that their importance scores would be identical if both of the assets would have reported to the STEM).

In some cases, the organizational cyber security system 200 can be configured to determine the importance scores of the assets also based on their location within the organizational network 100 (and optionally also based on the permissions information of block 520 and/or also based on the hierarchy information of block 530 and/or also based on the analyzed content insights of block 540 and/or also based on the analyzed metadata of block 550 and/or also based on the configurations information of block 560 and/or also based on the STEM information of block 570). For example, an asset that is behind a firewall protecting parts of the organizational network should have a higher importance score than another asset that is not behind the firewall (assuming that the importance scores of both assets would be identical if both of the assets were behind the firewall).

In some cases, the organizational cyber security system 200 is configured to continuously analyze network traffic passing through the organizational network 100 and identify usage patterns of use of the assets by the users (block 580). In such cases, the importance scores of the assets can be updated based on the identified usage patterns. In some cases, the usage patterns can indicate which users (optionally along with the hierarchy information which indicates the hierarchical position of the user in the organization) used which asset, at which frequency. For example, assuming that a CEO of an organization has access to two assets, and he accesses one of them more frequently than the other—the asset that is more frequently accesses can have an importance score higher than the other asset that is less frequently accessed.

For example, an asset that is more frequently used by the organization's CEO is more important than an asset that is less frequently used by the organization's CEO, and therefore it's importance score should be higher than that of the less frequently used asset (whose importance score would be identical if their use frequency by the organization's CEO was identical).

It is to be noted that in some cases, the organizational cyber security system 200 can enable a user thereof to provide input relating to the importance of one or more of the organizational assets. Accordingly, the organizational cyber security system 200 can be configured to receive, from a user thereof, importance information indicative of importance of one or more of the assets, and the importance scores of such assets can be updated based on the received importance information (block 590).

The asset discovery and ranking process 500 can be an ongoing process that is performed continuously or repeatedly, so that the importance scores are dynamic and can change over time due to activities performed on the organizational network 100 and/or on the organizational assets themselves.

It is to be noted that the scoring scheme can be based on assigning an equal baseline score for each of the organizational assets before the asset discovery and ranking process 500 begins, and adding/subtracting points from such baseline score based on the results of the processing performed at blocks 520-590.

It is to be noted that, with reference to FIG. 5, some of the blocks can be integrated into a consolidated block or can be broken down to a few blocks and/or other blocks may be added. Furthermore, in some cases, the blocks can be performed in a different order than described herein (for example, block 540 can be performed before block 530, etc.). It is to be further noted that some of the blocks (e.g. each of blocks 530-590) are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. An organizational cyber security system, the organizational cyber security system comprising processing circuitry configured, as part of performing a process, to:
obtain:
(a) organization characterization information characterizing an organization, the organization characterization information including at least one of: (i) organizational assets information of organizational assets of the organization, (ii) configurations information of configurations of the organizational assets, and (iii) relationships information of relationships between the organizational assets; and
(b) known threats information of known cyber security threats, wherein each of the cyber security threats poses a threat on respective target organizations associated with target characterization information including at least one of: (i) target organizational assets information of target organizational assets of the respective target organization, (ii) target configurations information of target configurations of the target organizational assets, and (iii) target relationships information of target relationships between the target organizational assets;
identify one or more potential threats of the known cyber security threats that pose the respective threats to the organization, being the known cyber security threats that are executable on the organizational assets according to the organization characterization information; and
generate one or more attack scenarios simulating execution of one or more of the potential threats on one or more of the organizational assets, being target organizational assets.

2. The organizational cyber security system of claim 1, wherein the processing circuitry is further configured, as part of performing the process, to repeatedly:
receive signals collected from at least one of the organizational assets, each of the signals being indicative of a respective activity performed on one or more of the organizational assets at a respective time; and
determine, for each of the attack scenarios, a risk score indicative of a likelihood of the respective attack scenario taking place on the organization by analyzing the signals.

3. The organizational cyber security system of claim 2, wherein at least some of the signals are (a) collected by agents executing on the organizational assets or (b) obtained from organizational alert systems.

4-5. (Cancelled)

6. The organizational cyber security system of claim 2, wherein the processing circuitry is further configured, as part of performing the process, to perform one or more manipulation actions manipulating the configurations of the organizational assets, or manipulating the relationships between the organizational assets, giving rise to updated organization characterization information.

7-9. (Cancelled)

10. The organizational cyber security system of claim 6, wherein the processing circuitry is further configured to reperform the process using the updated organization characterization information instead of the organization characterization information.

11. The organizational cyber security system of claim 3, wherein the processing circuitry is further configured, as part of performing the process, to perform one or more manipulation actions manipulating at least some of the agents, being manipulated agents.

12-13. (Cancelled)

14. The organizational cyber security system of claim 11, wherein the manipulation causes the respective agents to collect additional signals in addition to the signals.

15-19. (Cancelled)

20. The organizational cyber security system of claim 4, wherein the processing circuitry is further configured, as part of performing the process, to perform one or more manipulation actions manipulating at least some of the organizational alert systems, wherein the manipulation actions are determined based on characteristics of at least one given potential threat of the potential threats.

21-24. (Cancelled)

25. The organizational cyber security system of claim 2, wherein the processing circuitry is further configured, as part of performing the process, to perform one or more disruption actions for disrupting at least one given potential threat of the potential threats that is associated with at least one given attack scenario of the attack scenarios that is associated with a respective risk score that exceeds a threshold.

26. The organizational cyber security system of claim 25, wherein the disruption action includes deploying at least one honeypot on at least one of the organizational assets.

27. (canceled)

28. An organizational cyber security method, comprising, as part of performing a process:
obtaining, by a processing circuitry:
(a) organization characterization information characterizing an organization, the organization characterization information including at least one of: (i) organizational assets information of organizational assets of the organization, (ii) configurations information of configurations of the organizational assets, and (iii) relationships information of relationships between the organizational assets; and
(b) known threats information of known cyber security threats, wherein each of the cyber security threats poses a threat on respective target organizations associated with target characterization information including at least one of: (i) target organizational assets information of target organizational assets of the respective target organization, (ii) target configurations information of target configurations of the target organizational assets, and (iii) target relationships information of target relationships between the target organizational assets;
identifying, by the processing circuitry, one or more potential threats of the known cyber security threats that pose the respective threats to the organization, being the known cyber security threats that are executable on the organizational assets according to the organization characterization information; and
generating, by the processing circuitry, one or more attack scenarios simulating execution of one or more of the potential threats on one or more of the organizational assets, being target organizational assets.

29. The organizational cyber security system of claim 28, further comprising, as part of performing the process, repeatedly:
receiving, by the processing circuitry, signals collected from at least one of the organizational assets, each of the signals being indicative of a respective activity performed on one or more of the organizational assets at a respective time; and
determining , by the processing circuitry, for each of the attack scenarios, a risk score indicative of a likelihood of the respective attack scenario taking place on the organization by analyzing the signals.

30. The organizational cyber security system of claim 29, wherein at least some of the signals are (a) collected by agents executing on the organizational assets or (b) obtained from organizational alert systems.

31-32. (Cancelled)

33. The organizational cyber security system of claim 29, further comprising, as part of performing the process, performing, by the processing circuitry, one or more manipulation actions manipulating the configurations of the organizational assets, or manipulating the relationships between the organizational assets, giving rise to updated organization characterization information.

34-36. (Cancelled)

37. The organizational cyber security system of claim 33, further comprising reperforming the process using the updated organization characterization information instead of the organization characterization information.

38. The organizational cyber security system of claim 30, further comprising, as part of performing the process, performing, by the processing circuitry, one or more manipulation actions manipulating at least some of the agents, being manipulated agents.

39-40. (Cancelled)

41. The organizational cyber security system of claim 38, wherein the manipulation causes the respective agents to collect additional signals in addition to the signals.

42-46. (Cancelled)

47. The organizational cyber security system of claim 31, further comprising, as part of performing the process, performing, by the processing circuitry, one or more manipulation actions manipulating at least some of the organizational alert systems, wherein the manipulation actions are determined based on characteristics of at least one given potential threat of the potential threats.

48-51. (Cancelled)

52. The organizational cyber security system of claim 29, further comprising, as part of performing the process, performing, by the processing circuitry, one or more disruption actions for disrupting at least one given potential threat of the potential threats that is associated with at least one given attack scenario of the attack scenarios that is associated with a respective risk score that exceeds a threshold.

53-54. (Cancelled)

55. A non-transitory computer readable storage medium having computer readable program code embodied therewith, the computer readable program code, executable by at least one processor of a computer to perform a method comprising, as part of performing a process:
obtaining, by a processing circuitry:
(a) organization characterization information characterizing an organization, the organization characterization information including at least one of: (i) organizational assets information of organizational assets of the organization, (ii) configurations information of configurations of the organizational assets, and (iii) relationships information of relationships between the organizational assets; and
(b) known threats information of known cyber security threats, wherein each of the cyber security threats poses a threat on respective target organizations associated with target characterization information including at least one of: (i) target organizational assets information of target organizational assets of the respective target organization, (ii) target configurations information of target configurations of the target organizational assets, and (iii) target relationships information of target relationships between the target organizational assets;
identifying, by the processing circuitry, one or more potential threats of the known cyber security threats that pose the respective threats to the organization, being the known cyber security threats that are executable on the organizational assets according to the organization characterization information; and
generating, by the processing circuitry, one or more attack scenarios simulating execution of one or more of the potential threats on one or more of the organizational assets, being target organizational assets.
